(19) United States
(12) Patent Application Publication
(10) Pub. No.: US 2007/0112605 A1
(43) Pub. Date: May 17, 2007

(54) Software support insurance (SSI) policy

(76) Inventor: David Marc Dimston, Austin, TX (US)

Correspondence Address: VASANT V. CHAPHEKAR, 9104 CAIRA COVE, AUSTIN, TX, 78750, US

(21) Appl. No.: 11/273,035

(22) Filed: Nov. 12, 2005

(51) Int. Cl. G06Q 40/00

(52) U.S. Cl. 705/4

(57) ABSTRACT

In a method and system for providing a software support insurance (SSI) policy, an authorized copy of a source code for a software product is received. A software risk index for the software product is assessed, where the software risk index is a function of the source code, a support risk index is assessed, where the support risk index is a function of a time duration to support the source code, and a failure risk index is assessed, where the failure risk index is a function of a financial health of a provider of the software product. A premium for the SSI policy is computed as a function of the software risk index, the support risk index, and the failure risk index. The SSI policy provides insurance protection to the buyer to cover real and/or actual losses and also provides on-going technical assistance to the buyer.

### BACKGROUND

The present disclosure relates generally to insurance, and more particularly to tools and techniques for providing insurance policy products to mitigate real risks associated with a software product.

As the value and use of information continues to increase, individuals and businesses seek additional ways to acquire, process and store information. One option available to users is information processing systems. An information processing system (‘IPS’) generally processes, compiles, stores, and/or communicates information or data for business, personal, or other purposes thereby allowing users to take advantage of the value of the information. Because technology and information processing needs and requirements vary between different users or applications, information processing systems may also vary regarding what information is handled, how the information is handled, how much information is processed, stored, or communicated, and how quickly and efficiently the information may be processed, stored, or communicated. The variations in information processing systems allow for information processing systems to be general or configured for a specific user or specific use such as financial transaction processing, insurance business management, airline reservations, enterprise data storage, entertainment, and/or global communications. In addition, information processing systems may include a variety of hardware and software components that may be configured to process, store, and communicate information and may include one or more computer systems, data storage systems, and networking systems.

Presently, several innovative software products are being developed by companies for use in business and/or personal applications. For strategic, business, and/or technical reasons, buyers often invest several thousand and/or even millions of dollars to purchase a software product that may be early in its lifecycle. Due to the complexity in developing software products and the risks thereof, some buyers of the software products may elect not to become an early adopter of the software product and may allow someone else to carry the risk.

However, once purchased, the software product becomes an asset to the buyer. Support services like maintenance upgrades, bug fixes, software revisions, and the like are desired to protect the buyer's investment in the software product. Thus, it is desirable that a software company providing the software product also provide support services throughout the life cycle of the software product.

However, due to technical and/or business failures, the software company may be unable to provide the support services throughout the life cycle of the software product. Additionally, due to the proprietary nature of the software product, third parties interested in providing the support services may be unable to do so without obtaining access to the proprietary software. As a result, the buyer may incur substantial losses due to the improper support and maintenance to keep the software product operational. The potential risk of a failure to deploy the software product as an asset to produce intended results may prevent certain buyers to make the initial purchase.

Therefore, a need exists to provide an improved method and system for providing software support insurance. Accordingly, it would be desirable to provide a method and an information processing system for managing insurance policy products to mitigate real risks associated with a software product, absent the disadvantages found in the prior methods discussed above.

### SUMMARY

The foregoing need is addressed by the teachings of the present disclosure, which relates to a system and method for providing software support insurance. According to one embodiment, in a method and system for providing a software support insurance (SSI) policy, an authorized copy of a source code for a software product is received. A software risk index for the software product is assessed, where the software risk index is a function of the source code, a support risk index is assessed, where the support risk index is a function of a time duration to support the source code, and a failure risk index is assessed, where the failure risk index is a function of a financial health of a provider of the software product. A premium for the SSI policy is computed as a function of the software risk index, the support risk index, and the failure risk index. The SSI policy provides insurance protection to the buyer to cover real and/or actual losses and also provides on-going technical assistance to the buyer.

Several advantages are achieved by the method and system according to the illustrative embodiments presented herein. The embodiments advantageously provide for an improved insurance policy to protect against real losses incurred due to a failure in the software product. In addition, the policy also assures continued technical support for the software product over its lifecycle.

### BRIEF DESCRIPTION OF THE DRAWINGS

FIG. 1A illustrates a block diagram of a system for insurance information processing (IIP), according to an embodiment;

FIG. 1B illustrates a block diagram of an information processing system (IPS), according to an embodiment;

FIG. 2 is a block diagram illustrating a software support insurance (SSI) policy, according to an embodiment; and

FIG. 3 is a flow chart illustrating a method for providing software support insurance, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements.

The following terminology may be useful in understanding the present disclosure. It is to be understood that the terminology described herein is for the purpose of description and should not be regarded as limiting.

Device—Any machine or component that is operable to perform at least one predefined function. Examples of devices used in an IPS include power supplies, fan assemblies, displays, controllers, disk drives, scanners, cameras, printers, speakers, keyboards, and communication interfaces. Many devices may require a software program called a device driver program that acts as a translator between an application program and the device, or between a user and the device.

System—One or more interdependent devices that co-operate to perform one or more predefined functions.

For purposes of this disclosure, an IPS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IPS may be a personal computer, including notebook computers, personal digital assistants, cellular phones, gaming consoles, a network storage device, or any other suitable device and may vary in size, shape, performance, functionality, and price. The information processing system may include random access memory (RAM), one or more processing resources such as central processing unit (CPU) or hardware or software control logic, ROM, and/or other types of nonvolatile memory. Additional components of the information processing system may include one or more disk drives, one or more network ports for communicating with external devices as well as various input and output (I/O) devices, such as a keyboard, a mouse, and a video display. The information processing system may also include one or more buses operable to receive/transmit communications between the various hardware components.

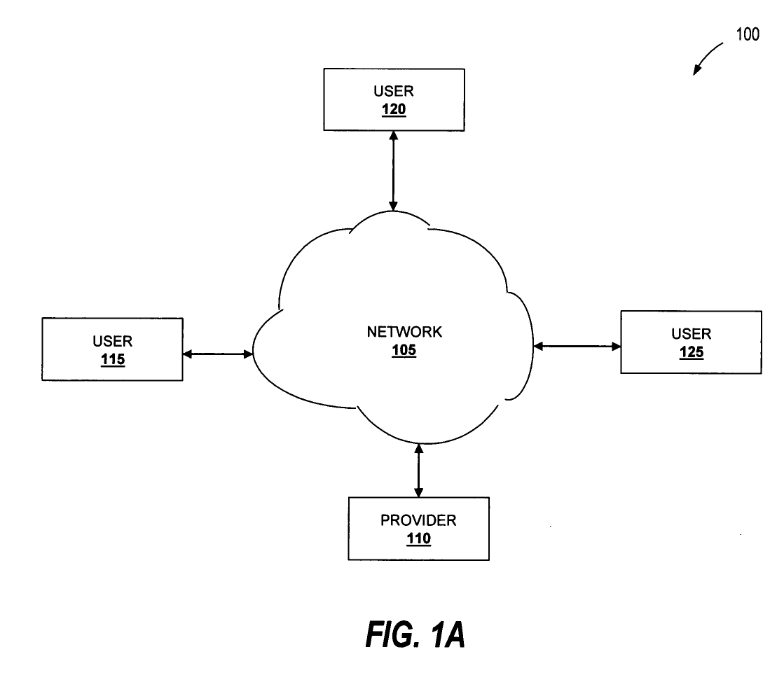

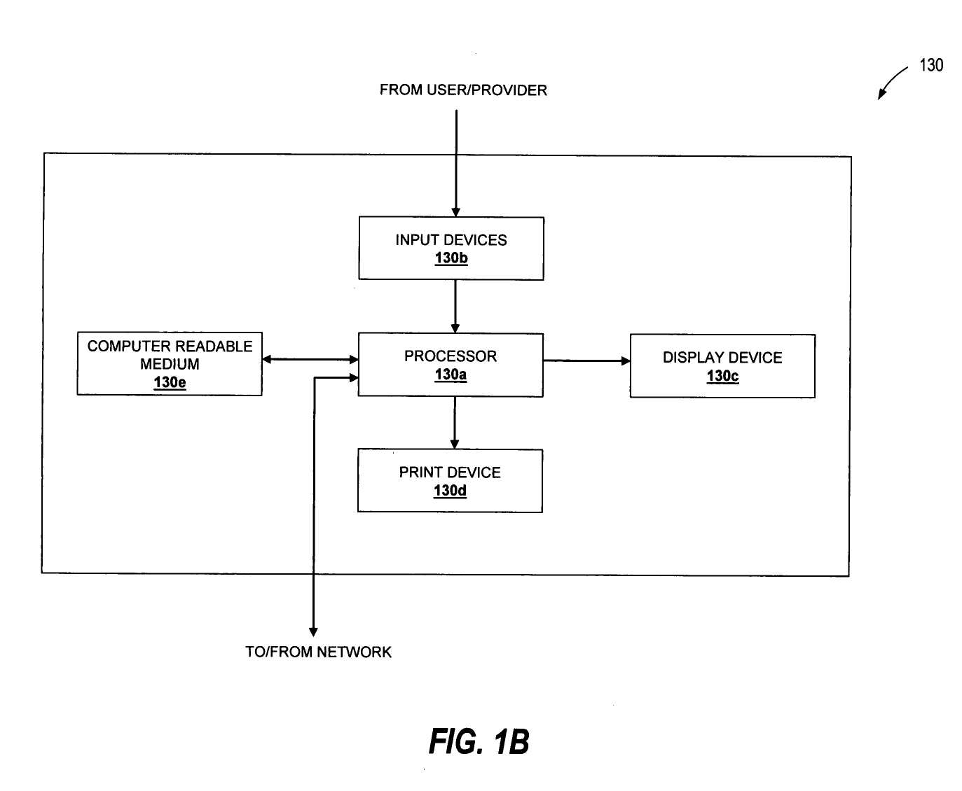

Referring now to FIG. 1A, in one embodiment, a system for insurance information processing (IIP) 100 is illustrated. The system 100 includes a computer network 105 such as, for example, a Transport Control Protocol/Internet Protocol (TCP/IP) network (e.g., the Internet or an intranet). An insurance provider 110 is operably coupled to the network 105. A plurality of users 115, 120, and 125 are also operably coupled to the network 105 in order to allow communication between the users 115, 120, and 125 and the provider 110. Examples of an insurance provider may include an insurance company providing insurance products, a re-insurance company providing re-insurance products to the insurance companies, and similar others. Examples of a user may include a policy holder, a sales agent, a potential buyer of a new policy, a researcher, and similar others.

Each of the provider 110 and the users 115, 120, and 125 includes a respective network interface for communicating with the network 105 (e.g., outputting information to, and receiving information from, the network 105), such as by transferring information (e.g., instructions, data, signals) between such users and the network 105. Accordingly, through the network 105, the provider 110 communicates with the users 115, 120, and 125, and the users 115, 120, and 125 communicate with the provider 110.

For clarity, FIG. 1A depicts only one provider 110. However, the system 100 may include a plurality of providers. Likewise, for clarity, FIG. 1A depicts only three users 115, 120, and 125. However, the IIP system 100 may include a plurality of users. In the discussion below, the user 115 is a representative one of the users 115, 120, and 125.

Each of the provider 110 and the users 115, 120, and 125 includes a respective information processing system (IPS), a subsystem, or a part of a subsystem for executing processes and performing operations (e.g., processing or communicating information) in response thereto, as discussed further below. Each such IPS is formed by various electronic circuitry components. Moreover, as illustrated in FIG. 1a, all such IPS's are coupled to each other. Accordingly, the provider 110 and the users 115, 120, and 125 operate within the network 105.

An IPS is an electronic device capable of processing, executing or otherwise processing information. Examples of an IPS include a server computer, a personal computer (e.g., a desktop computer or a portable computer such as, for example, a laptop computer), or a handheld computer. Additional examples of an IPS may also include a router, a switch and other devices coupled to a network (e.g. the network 105).

Referring now to FIG. 1B, an IPS 130 which is representative of one of the IPS's described above, is illustrated. The IPS 130 may include any or all of the following: (a) a processor 130a for executing and otherwise processing instructions, (b) a plurality of input devices 130b, which are operably coupled to the processor 130a, for inputting information, (c) a display device 130c (e.g., a conventional electronic cathode ray tub (CRT) device or a conventional liquid crystal display (LCD)), which is operably coupled to the processor 130a, for displaying information, (d) a print device 130d (e.g. a conventional electronic printer or plotter), which is operably coupled to the processor 130a, for printing visual images (e.g., textual or graphic information on paper), (e) a computer readable medium 130e, which is operably coupled to the processor 130a, for storing information, as discussed further below, and (f) various other electronic circuitry for performing other operations of the IPS 130 known in the art. It should be understood that the term “information processing system” is intended to encompass any device having a processor that executes instructions from a memory medium.

The IPS 130 includes (a) a network interface (e.g., circuitry) for communicating between the processor 130a and the network 105 and (b) a memory device (e.g., random access memory (RAM) device or read only memory (ROM) device for storing information (e.g., instructions included in a software program executed by processor 130a and data operated upon by processor 130a in response to such instructions)). The communications may occur over wired and/or wireless media. Accordingly the processor 130a is operably coupled to the network 105, the input devices 130b, the display device 130c, the print device 130d, and the computer readable medium 130e, as illustrated in FIG. 1B.

In response to signals from the processor 130a, the display device 130c displays visual images. Information may be input to the processor 130a from the input devices 130b, and the processor 130a may receive such information from the input devices 130b. Also, in response to signals from the processor 130a, the print device 130d prints visual images on paper.

The input devices include a variety of input devices known in the art such as, for example, a conventional electronic keyboard and a pointing device such as, for example, a conventional electronic “mouse”, rollerball, or light pen. The keyboard may be operated to input alphanumeric text information to the processor 130a, and the processor 130a may receive such alphanumeric text information from the keyboard. The pointing device may be operated to input cursor-control information to the processor 130a, and the processor 130a may receive such cursor control information from the pointing device.

The IPS 130 includes an operating system (OS). The OS is a type of software program that controls execution of other software programs, referred to as application software programs. In various embodiments the instructions and/or software programs may be implemented in various ways, including procedure-based techniques, component-based techniques, and/or object-oriented techniques, among others. Examples include assembler, C, XML, C++ objects, Java and Microsoft's NET technology.

The computer readable medium 130e and the processor 130a are structurally and functionally interrelated with one another as described below in further detail. Each IPS of the illustrative embodiment is structurally and functionally interrelated with a respective computer readable medium, similar to the manner in which the processor 130a is structurally and functionally interrelated with the comptuer readable medium 130e. In that regard, the computer readable medium 130e is a representative one of such computer readable media including, for example, but not limited to, a hard disk drive.

The computer readable medium 130e stores (e.g., encodes, records, or embodies) functional descriptive material (e.g., including but not limited to software (also referred to as computer programs or applications) or data structures). Such functional descriptive material imparts functionality when encoded on the computer readable medium 130e. Also, such functional descriptive material is structurally and functionally interrelated to the computer readable medium 130e.

With such functional descriptive material, data structures define structural and functional interrelationships between such data structures and the computer readable medium 130e (and other aspects of the system 100). Such interrelationships permit the data structures' functionality to be realized. Also, within such functional descriptive material, computer programs define structural and functional interrelationships between such computer programs and the computer readable medium 130e (and other aspects of the system 100). Such interrelationships permit the computer programs' functionality to be realized.

For example, the processor 130a reads (e.g., accesses or copies) such functional descriptive material from the computer readable medium 130e onto the memory device of the IPS 130, and the IPS 130 (more particularly, the processor 130a) performs its operations (as described elsewhere herein) in response to such material which is stored in the memory device of the IPS 130. More particularly, the processor 130a performs the operation of processing a computer application (that is stored, encoded, recorded, or embodied on a computer readable medium) for causing the processor 130a to perform additional operations (as described elsewhere herein). Accordingly, such functional descriptive material exhibits a functional interrelationship with the way in which processor 130a executes its processes and performs its operations.

Further, the computer readable medium 130e is an apparatus from which the computer application is accessible by the processor 130a, and the computer application is processable by the processor 130a for causing the processor 130a to perform such additional operations. In addition to reading such functional descriptive material from the computer readable medium 130e, the processor 130ais capable of reading such functional descriptive material from (or through) the network 105 which is also a computer readable medium (or apparatus). Moreover, the memory device of the IPS 130 is itself a computer readable medium (or apparatus).

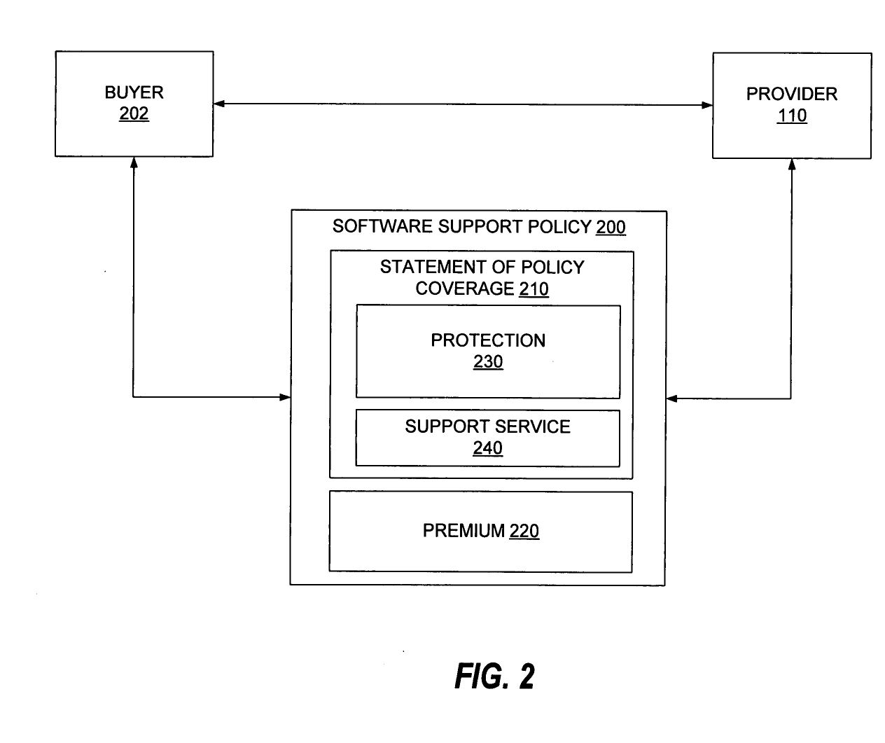

FIG. 2 is a block diagram illustrating a software support insurance (SSI) policy 200, according to an embodiment. In the depicted embodiment, the SSI policy 200 includes a statement of policy coverage 210 and a premium 220 payable to obtain the policy coverage. A buyer 202, who may be logged on to the network 105 (not shown) as one of the users 115, 120, and 125, may access, review, research, and/or purchase the SSI policy 200 offered by a broker and/or an insurance company, e.g., the provider 110. In a particular embodiment, the SSI policy 200 may be purchased substantially concurrent with a purchase of a software product. The SSI policy 200 provides insurance protection to the buyer 202 to cover real and/or actual losses arising due to a failure of the software product that is purchased and deployed as an asset. The real and/or actual losses may include cost of the software product. The SSI policy 200 offers a selectable coverage that provides a predefined range of monetary compensation for a loss incurred due to the failure. In addition, the SSI policy 200 also provides on-going technical assistance to the buyer 202.

In the depicted embodiment, the statement of policy coverage 210 includes a protection 230 against failure of a software product provided by a software company, and a support service 240 for the software product in the event the software company is unable to provide the support service. The buyer 202 may select a maximum coverage value for the protection 230. The failure of the software product may occur due to several reasons. For example, a software company operating in a startup phase may lack the experience and training to deliver the software product on time and with the agreed upon functionality. As another example, the failure of the software product may occur when the startup software company ceases to exist and/or if no resources are available to install and support the software product. In general terms, the failure of the software product may be defined as an occurrence of the software product not providing an output that is in compliance with at least one predefined output and/or performance criteria.

In a particular embodiment, the SSI policy 200 initiates the support service 240 for the software product in the event the software company is unable to provide the technical support, e.g., in the event the startup software company runs out of financial resources. In another embodiment, the software company may outsource the support function to another software support company, with the support service 240 being provided by the software support company from the date of the initial purchase of the SSI policy 200.

The support service 240 is provided to the buyer 202 for a selectable time duration. The SSI policy 200 may also define additional performance criteria and/or quality of service (QOS) for the support service 240 such as maximum response time, 24×7 coverage, on-site support, escalation process, and similar others. In order to provide the support service 240, the software support company receives an authorized copy of a source code for the software product. Based on the complexity of the source code such as number of lines, language(s) used, availability of documentation, and similar others, the software support company staffs sufficient resources to meet QOS criteria. The SSI policy 220 assures the buyer 202 of continued support for the software product, such as maintenance upgrades, bug fixes, and performance improvements, during the predefined time period.

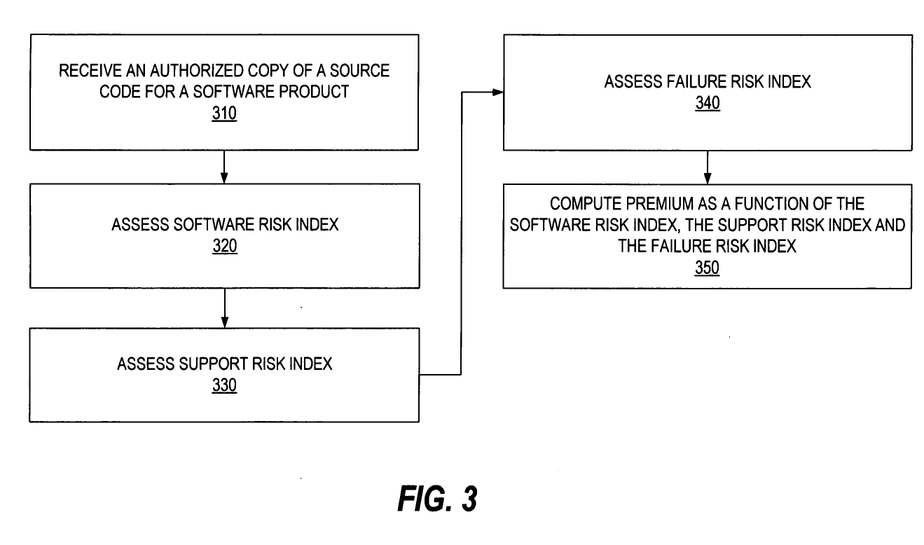

In a particular embodiment, the premium 220 is computed by the IIP 100 system. In an embodiment, determination of the premium 220 is made on a case-by-case basis depending on the complexity of each software product, the level of support desired and the estimated financial risk. A source code analysis and/or evaluation performed on the software product that drives a sizing algorithm to generate a software risk index for the software product. Similarly, an analysis and/or evaluation of the support level desired by the buyer 202 to maintain the software product generates a support risk index and an analysis/evaluation of the financial status of the software company providing the software product generates a failure risk index. Thus, the software product and source code analysis drives a sizing algorithm, which when combined with a risk assessment engine drives a sizing quotient and a failure risk probability to determine the premium 220. In a particular embodiment, the premium 220 is computed as a function of the software risk index for the software product, the support risk index for the support service 240, and the failure risk index for the software company. Additional detail of the computation of the premium 220 is described with reference to FIG. 3.

FIG. 3 is a flow chart illustrating a method for providing software support insurance, according to an embodiment. In step 310, an authorized copy of a source code for a software product is received. In step 320, a software risk index is assessed for the software product. The software risk index is indicative of the software technology and architectural complexity of the software product. In a particular embodiment, the software risk index is defined as a function of a programming language, level of documentation, portability, number of lines of the source code, number of ‘go to’ instructions, reusability, number of source code revision levels in a one year period, maintainability of the source code, and similar others. For example, a poorly documented software product having several thousand lines of source code may be assessed as a very high risk and a well structured, self documented, object oriented software product may be assessed as a low risk.

In step 330, a support risk index that is indicative of the level of support desired by the buyer 202 is assessed as a function of the source code and QOS related characteristics of the support services 240 such as a time duration. In a particular embodiment, the support risk index is dependent on a level of service desired such as L1 (front line support for known issues/known answers), L2 (dedicated technical support to reproduce problem, analyze and advise configuration change), and L3 (dedicated development engineer to custom engineer solution and change source code).

In step 340, a failure risk index that is indicative of a financial health of the software company is assessed as a function of a plurality financial ratios. In a particular embodiment, financial ratios or metrics for the software company may include income statement, balance sheet, working capital, availability of funding for the previous year and the next year, cumulative time with a positive cash flow, funding burn rate, and similar others.

In step 350, a premium for the insurance policy is computed as a function of the software risk index, the support risk index, and the failure risk index. Each of the risk indices may be defined as a numeric value ranging from a minimum value, e.g., 0, to a maximum value, e.g., 100. In a particular embodiment, the premium is computed as a weighted function, e.g., the failure risk index may carry a higher weight compared to the software risk index.

Various steps described above may be added, omitted, combined, altered, or performed in different orders. In a particular embodiment, the steps 310, 320, 330, 340 and 350 may be repeated for another software product provided by the same software company.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware, software and methods illustrated herein may vary depending on the implementation. For example, it should be understood that while the various risk indices are described by a function, it would be within the spirit and scope of the invention to encompass an embodiment deploying a more complex algorithm.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A software support insurance (SSI) policy, the policy comprising:
a statement of policy coverage, wherein the statement of policy coverage provides:
a protection against failure of a software product provided by a software company;
a support service for the software product when the software company is unable to provide the support service; and
a premium in accordance with the statement of policy coverage.

2. The policy of claim 1, wherein the support service is provided by a software support company that is different than the software company.

3. The policy of claim 2, wherein the support service is provided by the software support company after a financial failure of the software company.

4. The policy of claim 3, the software service company receives an authorized copy of a source code of the software product to provide the support service.

5. The policy of claim 1, wherein the support service is selectable for a predefined interval of time.

6. The policy of claim 1, wherein the protection against the failure of the software product is selectable to cover a predefined range of monetary compensation for a monetary loss incurred due to the failure.

7. The policy of claim 6, wherein the monetary loss is incurred by a policy holder due to an interruption of operation.

8. The policy of claim 1, wherein the failure is defined as an occurrence of the software product not being in compliance with at least one predefined performance criteria.

9. The policy of claim 1, wherein the failure is defined as an occurrence of the software product not providing an output that is in compliance with at least one predefined output.

10. The policy of claim 1, wherein the premium is computed as a function of a software risk index for the software product, a support risk index for the support service, and a failure risk index for the software company.

11. The policy of claim 10, wherein the premium is computed by an information processing system (IPS).

12. The policy of claim 1, wherein the support service defines a plurality of performance criteria, wherein one of the plurality of performance criteria is a maximum allowable response time.

13. A method for providing insurance, the method comprising:
receiving an authorized copy of a source code for a software product;
assessing a software risk index for the software product, wherein the software risk index is a function of the source code;
assessing a support risk index, wherein the support risk index is a function of a time duration to support the source code;
assessing a failure risk index, wherein the failure risk index is a function of a plurality financial ratios; and
computing a premium for the insurance as a function of the software risk index, the support risk index, and the failure risk index.

14. The method of claim 13, wherein the software complexity index is assessed by at least one factor, wherein the at least one factor includes one of a programming language type and a number of lines included in the source code.

15. The method of claim 13, wherein the support risk index is assessed by at least one factor, wherein the at least one factor includes one of a time duration for providing support and a response time.

16. The method of claim 13, wherein the failure risk index is assessed by at least one factor, wherein the at least one factor includes one of a funding burn rate and a cumulative time with positive cash flow.

17. The method of claim 13, wherein each one of the software complexity index, the support risk index, and the failure risk index is defined as a numeric value ranging from a minimum value to a maximum value.

18. An insurance information processing (IIP) system comprising:
a processor; and
a memory storing instructions operable with the processor, the instructions being executed for:
receiving an authorized copy of a source code for a software product;
assessing a software risk index for the software product, wherein the software risk index is a function of the source code;
assessing a support risk index, wherein the support risk index is a function of a time duration to support the source code;
assessing a failure risk index, wherein the failure risk index is a function of a plurality financial ratios; and
computing a premium for an insurance policy as a function of the software risk index, the support risk index and the failure risk index.

19. The system of claim 18, wherein the software complexity index is assessed by at least one factor, wherein the at least one factor includes one of a programming language type and a number of lines included in the source code.

20. The system of claim 18, wherein the failure risk index is assessed by at least one factor, wherein the at least one factor includes one of a funding burn rate and a cumulative time with positive cash flow.
